(19) United States
(12) Patent Application Publication
(10) Pub. No.: US 2025/0213965 A1
(43) Pub. Date: Jul. 3, 2025

(54) GAMEPAD AND METHOD CAPABLE OF SWITCHING BUTTON IDENTIFIERS

(71) Applicant: Shenzhen Yisuma Network Technology Co.,Ltd, Shenzhen (CN)

(72) Inventor: YUNCHAO YUE, Shenzhen (CN)

(21) Appl. No.: 18/416,281

(22) Filed: Jan. 18, 2024

(30) Foreign Application Priority Data
Dec. 27, 2023 (CN) 202323595298.9

(51) Int. Cl. A63F 13/22; A63F 13/24; F21V 23/04; F21Y 113/13

(52) U.S. Cl. CPC A63F 13/22; A63F 13/24; F21V 23/04; F21Y 2113/13

(57) ABSTRACT

A gamepad capable of switching button identifiers includes a shell and buttons arranged in a manner of at least partially penetrating through a surface of the shell. Each button includes a light source component, a control device, a control device and a button cap. The light source component emits a first group of light or a second group of light. The control device is electrically connected to the light source component and controls the light source component to emit the first group of light or the second group of light in response to an input of a user. The grating sheet is arranged on an optical path where the first group of light is located and an optical path where the second group of light is located. The button cap is at least partially transparent or semi-transparent.

### CROSS-REFERENCE TO RELATED APPLICATIONS

The application claims priority of Chinese patent application CN2023235952989, filed on Dec. 27, 2023, which is incorporated herein by reference in its entireties.

### TECHNICAL FIELD

The present disclosure relates to the technical field of gamepads, and in particular, to a gamepad and method capable of switching button identifiers.

### BACKGROUND

With the vigorous development of the electronic gaming industry, more and more people play electronic games for relaxation in their daily lives. Among many types of games such as console games, handheld games, arcade games, computer games, and mobile games, the console games are particularly favored due to their good optimization function and strong immersion. When people play a console game, a gamepad is usually an indispensable game accessory.

At present, the existing gamepads on the market usually include XBOX gamepads and PS gamepads. For adaptation to various different console platforms, distributions of buttons on the gamepads are usually the same, but identifiers on the buttons are different. For example, positions of right buttons on a PS4 gamepad are XO□Δ; positions of right buttons of the XBOX gamepad arc ABXY; and positions of right buttons of a SWITCH gamepad are BAXY. When connecting a gamepad product to different platforms, a user needs to change different gamepads. This greatly increases the cost for purchasing gamepads, and the user experience is poor.

For this purpose, the present disclosure provides a gamepad capable of switching button identifiers, which can effectively solve the above problems. The gamepad has a simple structure and is convenient for switching the button identifiers.

### SUMMARY

In order to overcome the shortcomings of the prior art, the present disclosure provides a gamepad capable of switching button identifiers, which has a simple structure and is convenient for switching the button identifiers.

The present disclosure provides a gamepad capable of switching button identifiers, includes a shell and buttons arranged in a manner of at least partially penetrating through a surface of the shell, wherein each button includes: a light source component, wherein the light source component emits a first group of light or a second group of light; a control device, wherein the control device is electrically connected to the light source component and controls the light source component to emit the first group of light or the second group of light in response to an input of a user; a grating sheet, wherein the grating sheet is arranged on an optical path where the first group of light is located and an optical path where the second group of light is located, and the grating sheet refracts or reflects the first group of light or the second group of light; and a button cap, wherein the button cap is at least partially transparent or semi-transparent; the first group of light refracted or reflected by the grating sheet passes through the button cap and forms a first button identifier at a top of the button cap; and the second group of light refracted or reflected by the grating sheet passes through the button cap and forms a second button identifier at the top of the button cap.

As the improvement of the present disclosure, the light source component includes a first light source component and a second light source component; both the first light source component and the second light source component are electrically connected to the control device; the control device turns on or turns off the first light source component and/or the second light source component in response to the input of the user; the first light source component is turned on to emit the first group of light; and the second light source component is turned on to emit the second group of light.

As the improvement of the present disclosure, a frequency of the first group of light is not the same as a frequency of the second group of light.

As the improvement of the present disclosure, the first light source component and the second light source component are respectively arranged on two opposite sides of the button cap, and an incidence angle of the first group of light is different from an incidence angle of the second group of light.

As the improvement of the present disclosure, a first light guide part and a second light guide part are convexly arranged on a surface of the button cap; the first light source component is arranged towards the first light guide part; and the second light source component is arranged towards the second light guide part.

As the improvement of the present disclosure, the control device includes a button control panel; the button control panel is arranged inside the shell and corresponds to the buttons; the button control panel is provided with button electrical contacts; and the button caps resist against the button electrical contacts.

As the improvement of the present disclosure, the button control panel is a cross-shaped circuit board; there are four buttons; the four buttons are distributed in a diamond shape; and the cross-shaped circuit board is arranged between two adjacent buttons.

As the improvement of the present disclosure, end portions of the cross-shaped circuit board protrude and extend towards two sides to form two symmetrical mounting parts; and the first light source component and the second light source component are respectively arranged on the two mounting parts.

As the improvement of the present disclosure, the control device further includes a main control panel; and the main control panel is arranged inside the shell and is electrically connected to the button control panel.

The present disclosure also provides a method capable of switching button identifiers, includes: providing the gamepad capable of switching the button identifiers described above; generating a switching signal in response to an input of a user, and transmitting the switching signal to the light source component; and emitting, by the light source component, a first group of light or a second group of light according to the switching signal to switch the button identifiers on the tops of the button caps.

Beneficial effects of the present disclosure are as follows: By the arrangement of the above structure, during use, a user selectively inputs information according to a use requirement. The control device controls the light source component to emit the first group of light or the second group of light. When the light source component emits the first group of light, the first group of light is refracted or reflected by the grating sheet, passes through the button cap, and forms the first button identifier at the top of the button cap; when the light source component emits the second group of light, the second group of light is refracted or reflected by the grating sheet, passes through the button cap, and forms the second button identifier at the top of the button cap. The user can easily change the button identifiers at the tops of the buttons with just a simple input, so that the gamepad is suitable for diversified use requirements of the user. An identifier change button can be arranged on the gamepad, so that the user can press or touch the identifier change button to achieve change the button identifiers. The button identifiers can also be changed by a long press on the buttons, or the button identifiers can also be switched by using a Hall switch to achieve inputting by the user.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an entire structure of the present disclosure;

FIG. 2 is a schematic diagram of an exploded structure according to the present disclosure;

FIG. 3 is a partially schematic structural diagram in an angle according to the present disclosure;

FIG. 4 is a partially schematic structural diagram in another angle according to the present disclosure;

FIG. 5 is a schematic diagram of a cross-sectional structure according to the present disclosure;

FIG. 6 is a partially schematic structural diagram of displaying a first button identifier according to the present disclosure;

FIG. 7 is a partially schematic structural diagram of displaying a second button identifier according to the present disclosure; and

FIG. 8 is a partially schematic structural diagram of displaying other button identifiers according to the present disclosure.

### DETAILED DESCRIPTION OF THE EMBODIMENTS

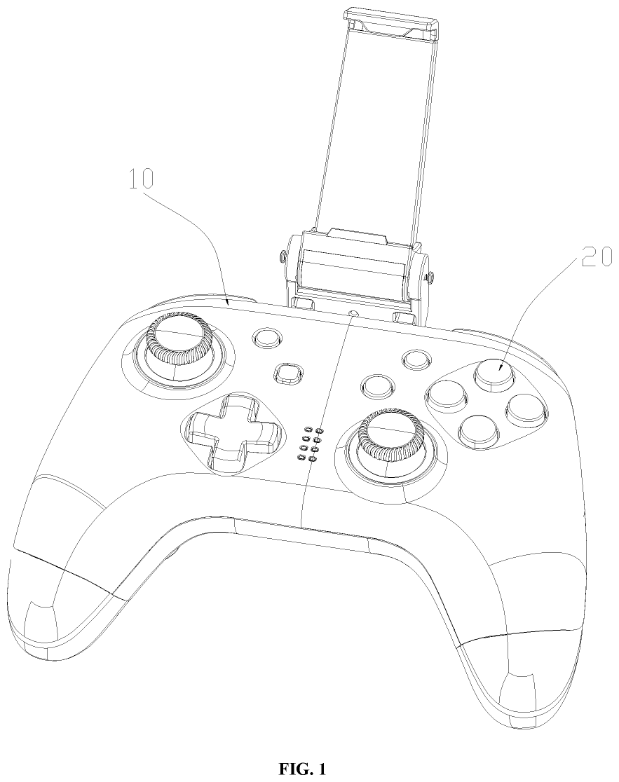

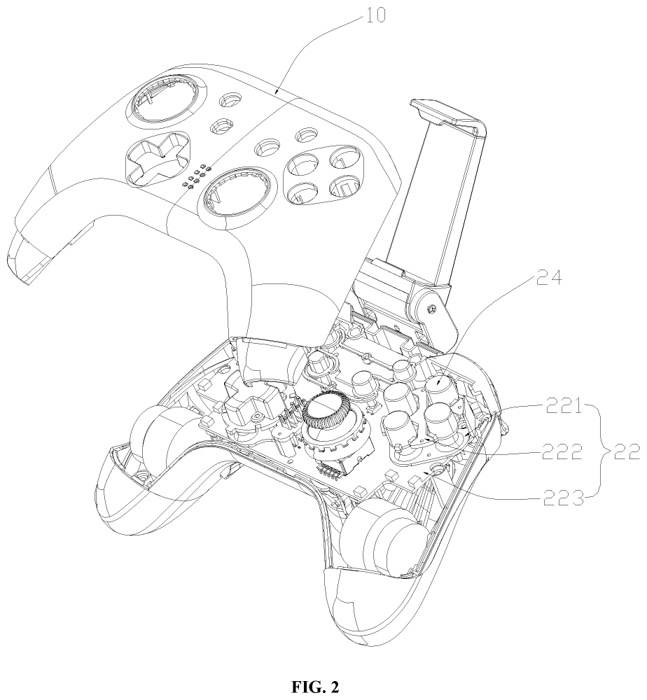

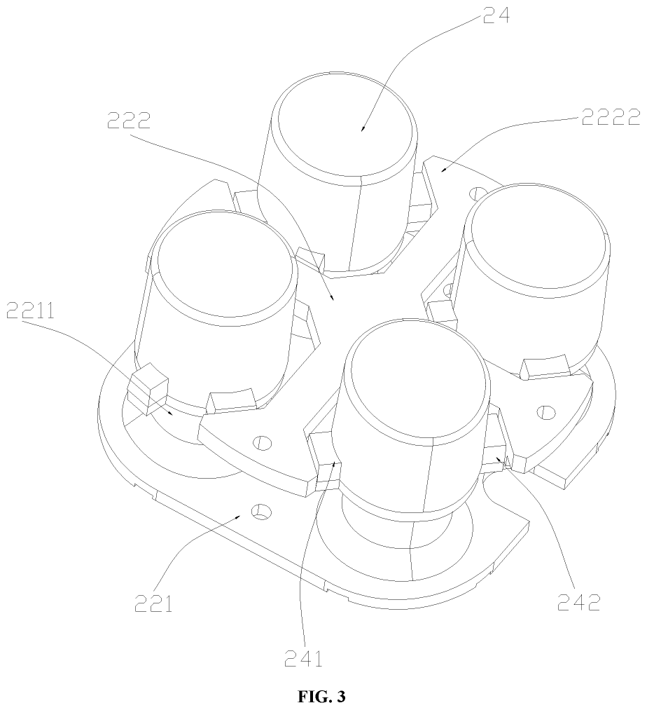

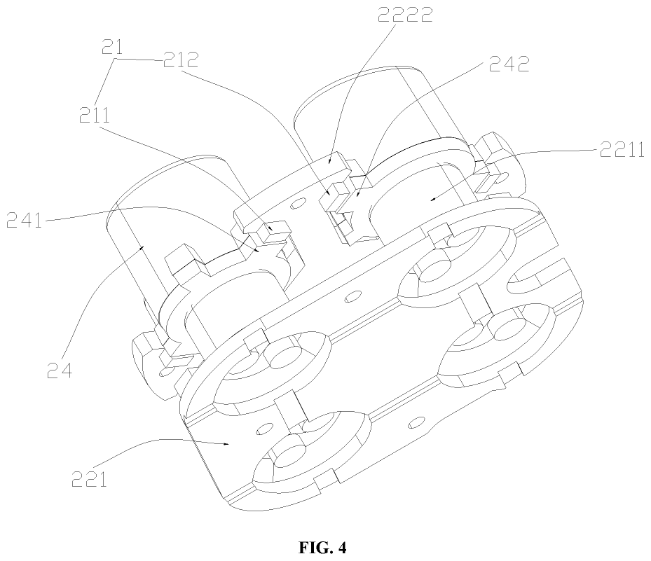

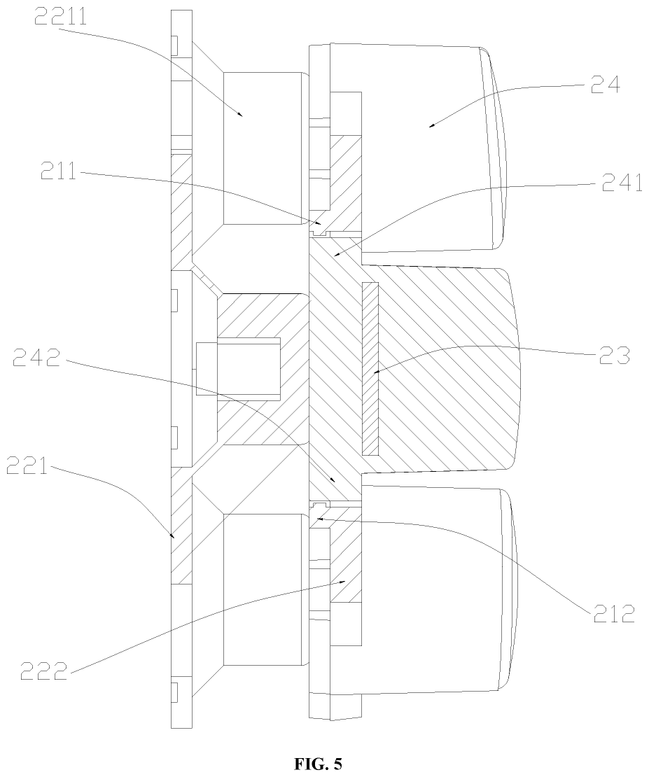

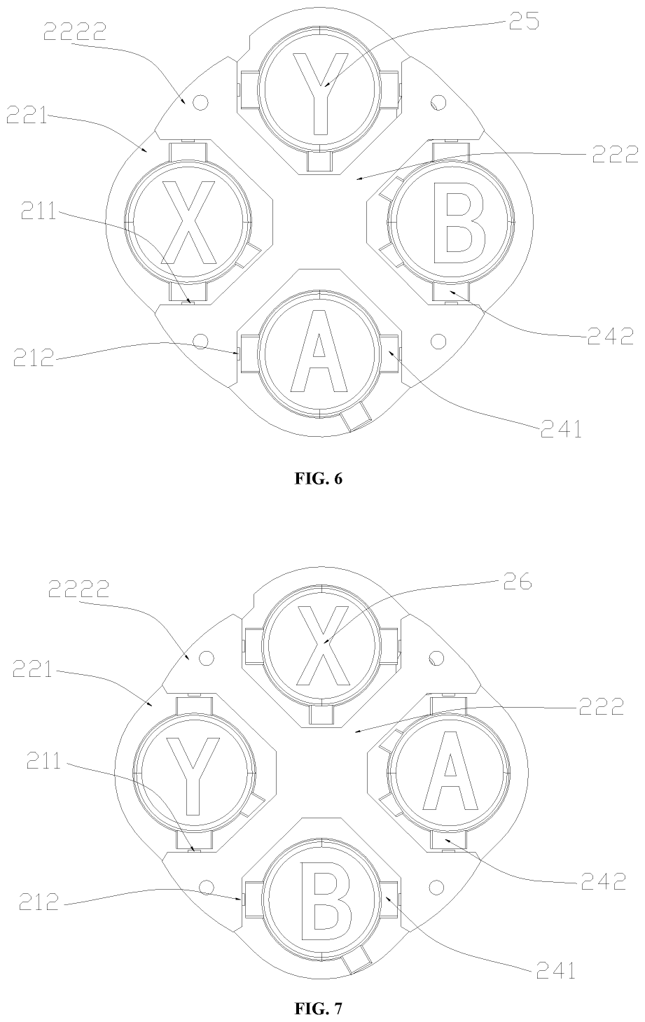

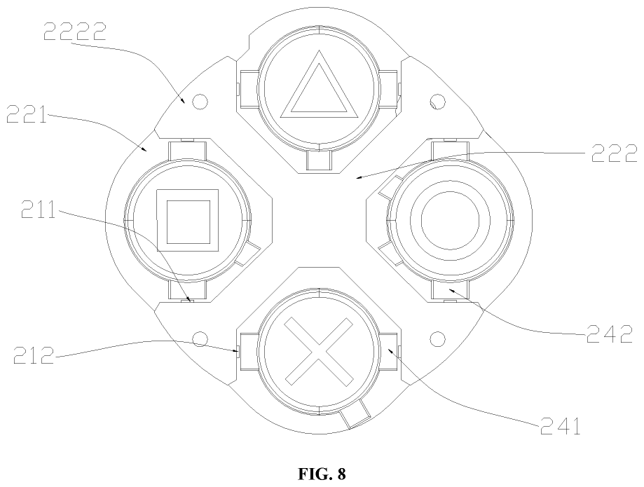

Referring to FIG. 1 to FIG. 8, a gamepad capable of switching button identifiers includes: a shell 10 and buttons 20 arranged in a manner of at least partially penetrating through a surface of the shell 10, wherein each button 20 includes: a light source component 21, wherein the light source component 21 emits a first group of light or a second group of light; a control device 22, wherein the control device 22 is electrically connected to the light source component 21 and controls the light source component 21 to emit the first group of light or the second group of light in response to an input of a user; a grating sheet 23, wherein the grating sheet 23 is arranged on an optical path where the first group of light is located and an optical path where the second group of light is located, and the grating sheet 23 refracts or reflects the first group of light or the second group of light; and a button cap 24, wherein the button cap 24 is at least partially transparent or semi-transparent; the first group of light refracted or reflected by the grating sheet 23 passes through the button cap 24 and forms a first button identifier 25 at a top of the button cap 24; and the second group of light refracted or reflected by the grating sheet 23 passes through the button cap 24 and forms a second button identifier 26 at the top of the button cap 24.

By the arrangement of the above structure, during use, a user selectively inputs information according to a use requirement. The control device 22 controls the light source component 21 to emit the first group of light or the second group of light. When the light source component 21 emits the first group of light, the first group of light is refracted or reflected by the grating sheet 23, passes through the button cap 24, and forms the first button identifier 25 at the top of the button cap 24; when the light source component 21 emits the second group of light, the second group of light is refracted or reflected by the grating sheet 23, passes through the button cap 24, and forms the second button identifier 26 at the top of the button cap 24. The user can easily change the button identifiers at the tops of the buttons with just a simple input, so that the gamepad is suitable for diversified use requirements of the user. An identifier change button can be arranged on the gamepad, so that the user can press or touch the identifier change button to achieve change the button identifiers. The button identifiers can also be changed by a long press on the buttons, or the button identifiers can also be switched by using a Hall switch to achieve inputting by the user.

In this embodiment, the light source component 21 includes a first light source component 211 and a second light source component 212; both the first light source component 211 and the second light source component 212 are electrically connected to the control device 22; the control device 22 turns on or turns off the first light source component 211 and/or the second light source component 212 in response to the input of the user; the first light source component 211 is turned on to emit the first group of light; and the second light source component 212 is turned on to emit the second group of light. By the arrangement of the above structure, during use, the control device 22 controls the first light source component 211 and the second light source component 212 to be turned on or turned off respectively, which can effectively achieve separate emission of the first group of light or the second group of light, prevent mutual interference between the first light source component 211 and the second light source component 212, and improve the stability of the product.

In this embodiment, a frequency of the first group of light is not the same as a frequency of the second group of light. If the first group of light or the second group of light are not the same in frequency and wavelength, the first group of light or the second group of light is also different in color. After being refracted or reflected by the same grating sheet 23, the light can form different patterns, so as to change the button identifiers, making it convenient for the user to distinguish different button identifiers. Meanwhile, the button identifiers with different colors can allow the user to understand functions and working modes of the buttons with the button identifiers, making it convenient for the user to distinguish and use the buttons and improving the convenience of the product.

In this embodiment, the first light source component 211 and the second light source component 212 are respectively arranged on two opposite sides of the button cap 24, and an incidence angle of the first group of light is different from an incidence angle of the second group of light. By the arrangement of the above structure, the first group of light or the second group of light with different incidence angles can form different patterns after being refracted or reflected by the same grating sheet 23, to change the button identifiers and facilitate the user to distinguish different button identifiers.

In this embodiment, a first light guide part 241 and a second light guide part 242 are convexly arranged on a surface of the button cap 24; the first light source component 211 is arranged towards the first light guide part 241; and the second light source component 212 is arranged towards the second light guide part 242. By the arrangement of the above structure and the arrangement of the first light guide part 241 and the second light guide part 242, the light emitted by the first light source component 211 and the second light source component 212 can be effectively guided into the button cap 24 and then pass through the grating sheet 23, to finally form the different button identifiers at the top of the button cap 24, which reduces loss of the light, improves the brightness of the button identifiers, and enables the user to easily see the button identifiers.

In this embodiment, the control device 22 includes a button control panel 221; the button control panel 221 is arranged inside the shell 10 and corresponds to the buttons 20; the button control panel 221 is provided with button electrical contacts 2211; and the button caps 24 resist against the button electrical contacts 2211. By the arrangement of the above structure, during use, when the buttons 20 are pressed, the buttons 20 move downwards to trigger the electrical contacts 2211 to generate an electrical signal, so that the user can control a computer electronic device by touching the buttons, which can effectively achieve human-computer interactions between the user and product and facilitate use.

In this embodiment, the control device 22 further includes a light source control panel 222; the light source control panel 222 is a cross-shaped circuit board; there are four buttons 20; the four buttons are distributed in a diamond shape; and the light source control panel 222 is arranged between two adjacent buttons. By the arrangement of the above structure, the four buttons 20 arranged in the diamond shape can be easily touched and pressed by the user, so that the product is more convenient to use, and confusion will be avoided. Meanwhile, the light source control panel 222 is in the cross shape and is arranged between the four buttons 20, which allows the first light source component 211 and the second light source component 212 which are arranged on the light source control panel 222 to effectively get close and be in contact with the four buttons 20, so that the light can effectively pass through the grating sheet 23 and form the button identifiers on the surface of the button cap 24.

In this embodiment, end portions of the light source control panel 222 protrude and extend towards two sides to form two symmetrical mounting parts 2222; and the first light source component 211 and the second light source component 212 are respectively arranged on the two mounting parts 2222. By the arrangement of the above structure, the protruding mounting parts 2222 can make the first light source component 211 and the second light source component 212 closer to the first light guide part 241 and/or the second light guide part 242, and the light can be input forward along the first light guide part 241 and/or the second light guide part 242. This improves the efficiency of light propagation, prevents loss of light caused by the refraction, ensures the brightness of the button identifiers, formed by the light passing through the grating sheet 23, on the surface of the button cap 24, and facilitates the user to distinguish different button identifiers.

In this embodiment, the control device 22 further includes a main control panel 223; and the main control panel 223 is arranged inside the shell 10 and is electrically connected to the button control panel 221. By the arrangement of the above structure, during use, the user presses or touches the button 20 to generate an electrical signal. The main control panel 223 is electrically connected to button control panel 221, and the electrical signal can be transmitted to the main control panel 223. The main control panel 223 can output different control instructions according to the electrical signal, so that the human-computer interaction can be achieved through the button 20, which facilitates use.

Referring to FIG. 1 to FIG. 8, a method capable of switching button identifiers includes: the above gamepad capable of switching the button identifiers is provided;

a switching signal is generated in response to an input of a user, and the switching signal is transmitted to the light source component 21; and

the light source component 21 emits a first group of light or a second group of light according to the switching signal to switch the button identifiers on the tops of the button caps 24.

By the arrangement of the above structure, during use, a user selectively inputs information according to a use requirement. The control device 22 controls the light source component 21 to emit the first group of light or the second group of light. When the light source component 21 emits the first group of light, the first group of light is refracted or reflected by the grating sheet 23, passes through the button cap 24, and forms the first button identifier 25 at the top of the button cap 24; when the light source component 21 emits the second group of light, the second group of light is refracted or reflected by the grating sheet 23, passes through the button cap 24, and forms the second button identifier 26 at the top of the button cap 24. The user can easily change the button identifiers at the tops of the buttons with just a simple input, so that the gamepad is suitable for diversified use requirements of the user. An identifier change button can be arranged on the gamepad, so that the user can press or touch the identifier change button to achieve change the button identifiers. The button identifiers can also be changed by a long press on the buttons, or the button identifiers can also be switched by using a Hall switch to achieve inputting by the user.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A gamepad capable of switching button identifiers, comprising a shell and buttons arranged in a manner of at least partially penetrating through a surface of the shell, wherein each button comprises:
a light source component, wherein the light source component emits a first group of light or a second group of light;
a control device, wherein the control device is electrically connected to the light source component and controls the light source component to emit the first group of light or the second group of light in response to an input of a user;
a grating sheet, wherein the grating sheet is arranged on an optical path where the first group of light is located and an optical path where the second group of light is located, and the grating sheet refracts or reflects the first group of light or the second group of light; and
a button cap, wherein the button cap is at least partially transparent or semi-transparent; the first group of light refracted or reflected by the grating sheet passes through the button cap and forms a first button identifier at a top of the button cap; and the second group of light refracted or reflected by the grating sheet passes through the button cap and forms a second button identifier at the top of the button cap.

2. The gamepad capable of switching the button identifiers according to claim 1, wherein the light source component comprises a first light source component and a second light source component; both the first light source component and the second light source component are electrically connected to the control device; the control device turns on or turns off the first light source component and/or the second light source component in response to the input of the user; the first light source component is turned on to emit the first group of light; and the second light source component is turned on to emit the second group of light.

3. The gamepad capable of switching the button identifiers according to claim 2, wherein a frequency of the first group of light is not the same as a frequency of the second group of light.

4. The gamepad capable of switching the button identifiers according to claim 2, wherein the first light source component and the second light source component are respectively arranged on two opposite sides of the button cap, and an incidence angle of the first group of light is different from an incidence angle of the second group of light.

5. The gamepad capable of switching the button identifiers according to claim 2, wherein a first light guide part and a second light guide part are convexly arranged on a surface of the button cap; the first light source component is arranged towards the first light guide part; and the second light source component is arranged towards the second light guide part.

6. The gamepad capable of switching the button identifiers according to claim 2, wherein the control device comprises a button control panel; the button control panel is arranged inside the shell and corresponds to the buttons; the button control panel is provided with button electrical contacts; and the button caps resist against the button electrical contacts.

7. The gamepad capable of switching the button identifiers according to claim 6, wherein the control device further comprises a light source control panel; the light source control panel is a cross-shaped circuit board; there are four buttons; the four buttons are distributed in a diamond shape; and the light source control panel is arranged between two adjacent buttons.

8. The gamepad capable of switching the button identifiers according to claim 7, wherein end portions of the light source control panel protrude and extend towards two sides to form two symmetrical mounting parts; and the first light source component and the second light source component are respectively arranged on the two mounting parts.

9. The gamepad capable of switching the button identifiers according to claim 6, wherein the control device further comprises a main control panel; and the main control panel is arranged inside the shell and is electrically connected to the button control panel.

10. A method capable of switching button identifiers, comprising:
providing the gamepad capable of switching the button identifiers according to claim 1;
generating a switching signal in response to an input of a user, and transmitting the switching signal to the light source component; and
emitting, by the light source component, a first group of light or a second group of light according to the switching signal to switch the button identifiers on the tops of the button caps.
